(19) United States
(12) Patent Application Publication
(10) Pub. No.: US 2014/0214480 A1
(43) Pub. Date: Jul. 31, 2014

(54) DETERMINING A CUSTOMER PROFILE STATE

(71) Applicant: HEWLETT-PACKARD DEVELOPMENT COMPANY, LP., (US)

(72) Inventors: Zainab Jamal, Palo Alto, CA (US); Ravigopal Vennelakanti, Santa Clara, CA (US)

(73) Assignee: HEWLETT-PACKARD DEVELOPMENT COMPANY, L.P., Houston, TX (US)

(21) Appl. No.: 13/753,759

(22) Filed: Jan. 30, 2013

(51) Int. Cl. G06Q 30/02

(52) U.S. Cl. CPC G06Q 30/0201
USPC 705/7.29

(57) ABSTRACT

First data is received from a device, where the first data includes a usage pattern of the device by a customer. Second data of the customer is received from a social media source, the second data including information regarding sentiment about an attribute expressed by the customer. A profile state of the customer is determined based on the first data and the second data.

### BACKGROUND

Enterprises are continually trying to identify new offerings (products or services) or new features in existing offerings that may be attractive to customers. Due to the relatively high costs associated with development of offerings, enterprises want to ensure that new offerings or updated offerings (with new features) would be successful in the marketplace.

Some enterprises may perform customer surveys or form focus groups to obtain feedback from users regarding offerings or features of offerings. However, obtaining information based on surveys or focus groups may prove unreliable for determining the popularity of offerings or their features.

### BRIEF DESCRIPTION OF THE DRAWINGS

Some embodiments are described with respect to the following figures:

FIG. 1 is a schematic diagram of a system according to some implementations;

FIG. 2 is a flow diagram of a process according to some implementations; and

FIGS. 3 and 4 are block diagrams of modules of a customer profile generator according to various implementations.

### DETAILED DESCRIPTION

An enterprise, such as a business concern, a government agency, or an educational organization, may provide offerings to its customers. A customer can refer to an individual user, a group of users, or any other type of entity that can be considered to consume an offering provided by an enterprise. An offering can refer to a product or a service. As an enterprise develops new offerings or updates existing offerings, the enterprise may obtain feedback from customers (such as in answers to customer surveys or in answers to questionnaires submitted to focus groups) to identify offerings or features of offerings that may be attractive to customers. However, collecting feedback in this manner may not provide information that may be reliably used to identify new offerings or features that would be successful.

In accordance with some implementations, rather than just rely on feedback collected in surveys or in questionnaires submitted to customers, other types of information can be collected for ascertaining characteristics of offerings that may be attractive to customers. In some implementations, the other types of information that can be collected can include first data collected by a device associated with a customer, where this first data provides a usage pattern of the device by the customer. The usage pattern can correspond to a physical activity level of the customer, for example. Also, another type of information that can be collected includes second data from a social media source, such as a social networking website, a blog website, a product or service review website, or any other online system in which a customer can interact with other customers. Examples of social networking websites include Facebook®, Twitter®, and so forth.

Based on the first data collected by a device that is indicative of the usage pattern of a device, and second data collected from a social media source, profile information can be generated for the customer. In some implementations, the profile information can include a number of profile states and respective indications that indicate probabilities with respect to those profile states. A profile state can be a state that characterizes an attribute (or dimension) of the customer, such as a physical activity level dimension of the customer, or some other characteristic of the customer that is useable to determine offerings or features of offerings that may be attractive to the customer. The profile information can also be referred to as a customer lifestyle profile.

Examples of profile states can include the following: active state (which indicates that a customer is active), a passive state (which indicates that a customer is passive), competitive state (which indicates whether a customer competes in sports), runner state (which indicates whether a customer regularly runs or jogs), walker state (which indicates whether a customer regularly walks), city runner state (which indicates that a customer performs running in a city), trail runner state (which indicates that a customer runs on rugged trails), and so forth.

The customer lifestyle profile can include one or some combination of the foregoing example profile states, along with probability indication(s) for the respective profile state(s). A probability indication indicates how likely a customer would be at the respective profile state.

In accordance with some implementations, the first data collected by a device can be structured data, which conforms to a predefined format or schema. The device from which the first data is collected can include a sensor (or multiple sensors). The device can be a product (e.g. shoe, computer, smartphone, clothing, etc.), or any other type of device, and the sensor(s) can be included in the product.

The second data collected from a social media source can be unstructured data, which is data that does not conform to any predefined format or schema. Examples of unstructured data include freestyle text entered by users that can vary from user to user.

Techniques or mechanisms according to some implementations allow for automated collection of structured and unstructured data from various different sources for the purpose of determining the customer lifestyle profile of the customer. Based on the customer lifestyle profiles of customers, an enterprise can more reliably identify offerings or features of offerings that are likely to be more attractive to customers. For example, if the customer lifestyle profiles of various customers indicate that there is a substantial segment of the market that are interested in jogging shoes of an enterprise, and that these customers have expressed through social media postings features of particular interest to the customers, the enterprise can make a more intelligent decision to commit resources to developing running shoes that have the desired features identified in the social media postings.

Customer lifestyle profiles according to some implementations can also be used for purposes other than identifying offerings or features of offerings.

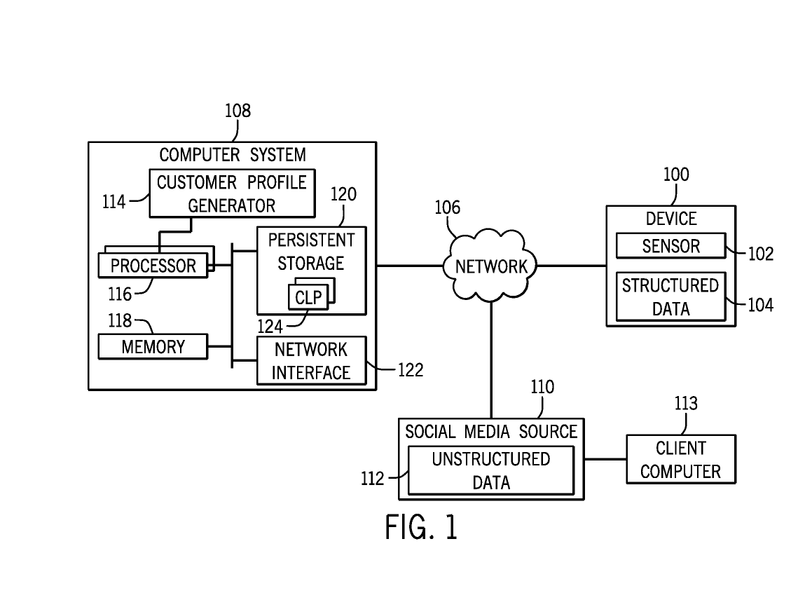

FIG. 1 illustrates an example arrangement according to some implementations. A customer can be associated with a device 100, which includes a sensor 102. In some examples, the device 100 can be a product that is provided by an enterprise. As an example, the device 100 can be a shoe that is worn by the customer. The sensor 102 can be embedded in the shoe. In other examples, the device 100 can be some other type of device.

The sensor 102 collects structured data 104 based on usage of the device 100. Although just one sensor 102 is depicted, it is noted that the device 100 can include multiple sensors. The structured data 104 collected by the sensor(s) 102 can thus provide information pertaining to a usage pattern of the device 100. The sensor(s) 102 can include any or some combination of the following: an accelerometer, a speed sensor, a temperature sensor, a location sensor (e.g. global positioning system or GPS sensor), and so forth.

The structured data 104 collected by the sensor(s) 102 can be communicated over a communications network 106 to a computer system 108. The communications network 106 can be a wireless network and/or a wired network. The sensor(s) 102 can track the activity of the device 100 as used by the customer. For example, information collected by the sensor 102 can track distances traveled by the customer, a number of times in a given time interval (e.g. week) that the customer runs or walks, the intensity (indicated by the speed of the customer, for example) of the runs or walks, the elevation of the runs or walks, the locations of the activities, and so forth.

The computer system 108 is also coupled over the communications network 106 with a social media source 110. The social media source 110 is accessible by the customer, such as from a client computer 113 (which can be a notebook computer, desktop computer, smartphone, etc.). At the social media source 110, the user can engage in interactions with other users, in the form of text postings, blogs, customer reviews, and so forth. Entries made by the user at the social media source 110 is in the form of unstructured data 112. The unstructured data 112 can be communicated over the communication network 106 to the computer system 108.

In interactions made by the customer at the social media source 110, the customer can write about the customer's activities. For example, the customer can write about the customer's runs and issues that the customer has with the customer's shoes, or about features of the shoes that the customer wishes the shoes had. The customer may complain about various features of the shoe. As an example, the user can complain that the shoes take a relative long time to dry after they get wet during rugged trail runs. The customer can write about the foregoing information in a blog. Alternatively, the customer may be part of an online social network group that discusses running. As yet another example, the customer can enter information such as customer reviews at a product or service review website.

More generally, the information provided by a customer at the social media source 110, can identify at least one attribute of a product or service, and can include text that express a sentiment of the customer with respect to the at least one attribute. The sentiment expressed by the customer about the at least one attribute can be useful to the enterprise to determine characteristics of an offering that are desired by the customer.

The computer system 108 has a customer profile generator 114, which can be implemented as machine-readable instructions executable on one or multiple processors 116. The processor(s) 116 can be coupled to a memory 118 and a persistent storage 120. In addition, the processor(s) 116 can be coupled to a network interface 122 to allow the computer system 108 to communicate over the communications network 106.

The customer profile generator 114 can generate a customer lifestyle profile 124 based on the structured data 104 from the sensor(s) 102 and based on the unstructured data 112 from the social media source 110. The customer lifestyle profile 124 produced by the customer profile generator 114 can be stored in the persistent storage 120, for subsequent retrieval by an enterprise interested in the customer lifestyle profile.

Note that the computer system 108 can collect information from multiple devices 100 and multiple postings associated with one or multiple social media sources 110, for various different customers. Consequently, the customer profile generator 114 can produce multiple corresponding customer lifestyle profiles 124.

Based on the customer lifestyle profiles 124, an enterprise can determine features to include in new offerings, or to upgrade features of existing offerings. The customer lifestyle profiles 124 can also be used for other purposes.

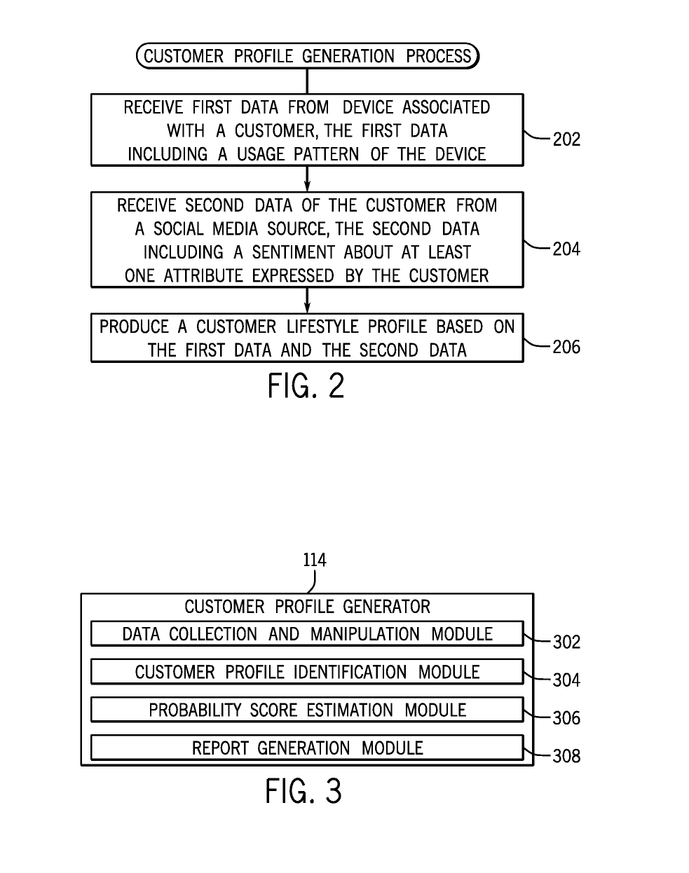

FIG. 2 is a flow diagram of an example process that can be performed by the customer profile generator 114 according to some implementations. The customer profile generator 114 receives (at 202) first data from the device 100 (or multiple devices) associated with a customer, where the first data includes a usage pattern of the device(s) 100 by the customer. The customer profile generator 114 also receives (at 204) second data from the customer from a social media source (or from multiple social media sources), where the second data includes information regarding sentiment about at least one attribute expressed by the customer. An “attribute” can represent any item about which the customer can express a sentiment, where the item can include a feature of an offering, the offering itself, a concept, a theme, or any other item.

For example, a customer can express sentiment (negative or positive sentiment) about a product such as a shoe, computer, and so forth. Also, the customer can express sentiment about some feature of the product, such as battery life of a computer, a drying feature of a shoe, and so forth. In cases where an offering is a service, a customer can also express a sentiment regarding some aspect of the service (e.g. poor website interface, unresponsive customer service agents, and so forth). Additionally, an attribute can include concepts or themes about which multiple users are discussing. For example, rather than discuss any particular offering from an enterprise, customers may generally discuss activities that the customers may be interested in, such as running in the mountains, and so forth.

Based on the first data and the second data, the customer profile generator 114 produces (at 206) a customer lifestyle profile 124. The customer lifestyle profile can include information pertaining to at least one profile state of the customer. The customer lifestyle profile can also include an indication of a probability of the profile state. There can be multiple profile states in the customer lifestyle profile, with corresponding probability indications assigned to the respective profile states.

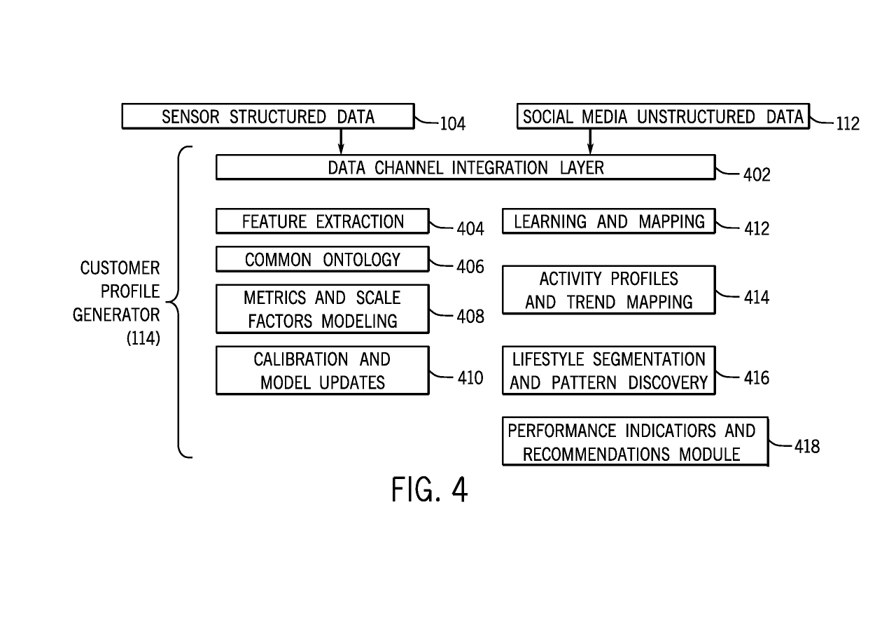

As shown in FIG. 3, the customer profile generator 114 can include modules 302, 304, 306, and 308. The module 302 is a data collection and manipulation module, which can collect structured data 104 from the sensor(s) 102 of the device 100, and which can also collect unstructured data 112 from the social media source 110.

The data collection and manipulation module 302 can analyze the unstructured data 112 from a social media source 110 to identify attributes in the unstructured data 112 and to derive weights and sentiment using text analytics. The text analytics can identify words or phrases in the unstructured data 112 that are likely to be attributes. For example, nouns are more likely to be attributes, while adjectives and adverbs are more likely to express sentiments about the attributes. The weights determined by the data collection and manipulation module 302 indicate relative importance of the respective attributes.

The structured data 104 and the unstructured data 112 can be organized by customer and time. For example, the structured data 104 collected by the sensor(s) 102 of the device 100 can be associated with an identifier of a customer. Also, the structured data 104 collected at different times can be associated with respective timestamps. Based on the customer identifiers and the timestamps, the data collection and manipulation module 302 is able to divide the structured data 104 by customer and by time. Similarly, the unstructured data 112 can also be associated with customer identifiers and timestamps, to allow the unstructured data 112 to be divided by customer and time.

The data collection and manipulation module 302 can also combine the structured data 104 and the unstructured data 112, for multiple customers and for data collected at different times. The combining can use a time-series and cross-sectional based technique that can aggregate the collected data (structured data and unstructured data) into different aggregation levels, such as different time intervals (e.g. days, weeks, months). For example, data can be collected on an hourly basis, and the data can be aggregated into one of multiple aggregation levels, such as days, weeks, months, etc. Also, the combining technique can form multiple groups of customers, such as customers grouped by age, gender, profession, and so forth.

The data collection and manipulation module 302 can also apply manipulation of the structured and unstructured data, as aggregated and divided using the time-series cross-sectional-based technique, into a target format or formats for use by other modules of the customer profile generator 114.

Table 1 below illustrates an example table derived from the structured data 104 of FIG. 1 by the data collection and manipulation module 302.

TABLE 1

| Customer | | | | Dis- | | |
|---|---|---|---|---|---|---|
| ID | Date | Time | Steps | tance | Speed | Elevation |
| 1001234 | 2012/06/22 | 04:30:00 | 1000 | 0.5 | 4.5 | 50 |
| 1001234 | 2012/06/22 | 05:00:00 | 5000 | 2.5 | 6.5 | 40 |
| 1001234 | 2012/07/02 | 04:00:00 | 1000 | 0.5 | 4.5 | 300 |
| 1002222 | 2012/04/12 | 18:30:00 | 5000 | 5 | 3 | 15 |
| 1002222 | 2012/04/13 | 18:30:00 | 5000 | 5 | 3 | 10 |
| 1003434 | 2012/05/12 | 07:00:00 | 100 | 1 | 2 | 10 |

The table includes various columns, including a “customer ID” column (to identify a customer), a “date” column (to identify a date of the respective structured data), a “time” column (to identify the time at which the data was collected), a “steps” column (to identify the number of steps taken by the customer), a “distance” column (to identify a distance traveled by the customer), a “speed” column (to identify the speed, such as an average speed, of the customer), and an “elevation” column (to identify the elevation of the customer).

Table 2 below illustrates an example table derived from the unstructured data 112 of FIG. 1 by the data collection and manipulation module 302.

TABLE 2

| Customer id | Source | time | attribute | category | sentiment | weight |
|---|---|---|---|---|---|---|
| 1001234 | http://www.facebook.com/ | 2012-06-30 | SF marathon | running | + | 5 |
| | pages/Running/93961945054 | T 10:45 UTC | | | | |
| 1002222 | http://www.facebook.com/ | 2012-06-28 | Hill training | running | − | 6 |
| | pages/Running/93961945054 | T 06:45 UTC | | | | |

Table 2 includes a “customer ID” column, a “source” column (to identify the social media source, such as in the form of a web address or uniform resource locator), a “time” column (to identify a time associated with a posting in the social media source), an “attribute” column (to identify an attribute determined from the unstructured data), a “category” column (to indicate the category of the attribute), a “sentiment” column (to indicate whether the sentiment is a positive sentiment (“+”) or a negative sentiment (“−”)), and a “weight” column (to indicate the relative importance of the corresponding attribute).

As further depicted in FIG. 3, the module 304 of the customer profile generator 114 is a customer profile identification module, which can identify profile states that are to be used in forming customer lifestyle profiles. The identified profile states can be generated a priori based on historical information about a given market or a given customer segment (e.g. customers of a given gender, customers in a given age group, etc.). Also, experts can provide their input regarding suggested profile states that may be included in customer lifestyle profiles generated by the customer profile generator 114.

Alternatively, the customer profile state identification module 304 can identify the profile states a posteriori based on the structured data 104 and the unstructured data 112 collected by the customer profile generator 114. For example, the customer profile state identification module 304 can apply a statistical technique, such as principle component analysis technique, a clustering technique, or a multi-dimensional scaling technique, to analyze the structured data 104 and unstructured data 112 for the purpose of identifying which profile states are to be included in customer lifestyle profiles 124.

The module 306 of the customer profile generator 114 is a probability score estimation module 306, for generating probability indications (e.g. in the form of scores) of probabilities for respective profile states in a given customer lifestyle profile. The probability score for each profile state can be computed using a statistical model such as a state-space model, a hidden Markov model, and so forth. The statistical model can provide the probability score of a customer belonging to a profile state in a current time period.

The probability score estimation module 306 can estimate the probability that a customer belongs to a given customer profile state, such as based on determining that the customer is more similar to a given set of customers at the given profile state than to other customers at other profile states, at any given point in time. Alternately, the probability score estimation module 306 can estimate the probability of a customer belonging to a profile state as function of attributes generated from the first and second data which can be customer specific, state specific or some combination thereof, where the customer's level (magnitude) of each of these attributes determines the customer's probability score at any given point in time. As the levels of these attributes change from one point in time to the next, the probability score estimation module 306 can generate the probability estimates for the new point in time. Further, based on the historic level of any attribute, the probability score estimation module 306 can predict the future level of that attribute for a given customer and the transition probability of the customer transitioning from one state to another among a finite set of states.

Also, the statistical model can determine the probability score of the customer transitioning from one profile state to another profile state during the current time period and in a future time period. For example, over time, the sensor data can indicate that a customer's average speed during each session has increased. Thus, the customer may have transitioned from a walker state (a profile state indicating the customer exercises by walking) to a runner state (a profile state indicating that the customer exercises by running).

As another example, a customer may transition from a passive state to an active state. To do so, the probability score estimation module 306 would have to determine that the sensor data has indicated that the customer is engaging in more activity (e.g. sensor data indicating that the customer is moving at greater speed more frequently). Based on the actual activity of the customer, the probability score estimation module 306 can assign a probability that the customer has made the transition between profile states, using a statistical model as discussed.

The module 308 of the customer profile generator 114 is a report generation module that can generate reports that contain diagnostics, recommendations, and other information that can be used by an enterprise, such as for purposes of identifying features or offerings of features that may be attractive to customers. A report produced by the report generation module 308 can include customer lifestyle profiles, for example. Alternatively, the report can combine the customer lifestyle profiles in aggregate form.

FIG. 4 is a block diagram of the customer profile generator 114 according to alternative implementations. As depicted in FIG. 4, the customer profile generator 114 receives structured data 104 from sensors and unstructured data 112 from social media sources. The various modules depicted in FIG. 4 may be included in some of the modules of FIG. 3, or may be in addition to the modules of FIG. 3.

The customer profile generator 114 includes a data channel integration layer 402, which integrates or combines the structured data 104 and the unstructured data 112. The combining of the structured data 104 and the unstructured data 112 allows the customer profile generator 114 to process the respective data.

In addition, the customer profile generator 114 includes a feature extraction module 404 and a common ontology 406. The feature extraction module 404 is able to extract attributes and sentiment words or phrases from the unstructured data 112, where the attributes are attributes about which sentiment can be expressed.

The common ontology 406 defines a set of concepts that are to be used by the feature extraction module 404. The concepts can identify the attributes, for example. The common ontology 406 can also be used to identify words or phrases that may be used as sentiments.

A metrics and scale factors modeling module 408 can identify various metrics that can be collected by different sensors, and can define scaling that is to be applied to the metrics to allow such metrics to be used. For example, metrics from different sensors may have different scales. These metrics would have to be appropriately scaled before the metrics can be properly used by the customer profile generator 114. The scaling of metrics from different sensors can be based on one or multiple models.

A calibration and model updates module 410 can be used to calibrate the models used by the metrics and scale factors modeling module 408. During operation, the customer profile generator 114 may determine that the models used by the metrics and scale factors modeling module 408 are no longer accurate, and thus may calibrate those models.

A learning and mapping module 412 can be used to learn the ontology of social media sources. Note that new attributes can continually be evolving in social media postings, such that the learning and mapping module 412 can identify such new attributes, for the purpose of collection into the unstructured data 112. In addition, the learning and mapping module 412 can map a physical activity level indicated by sensor data to a respective behavior of a customer. Over time, the learning and mapping module 412 can learn that a certain activity level indicated by the sensor data (e.g. the customer moving at a speed within a given range) can be mapped to one profile state rather than another profile state.

An activity profiles and trend mapping module 414 can produce customer lifestyle profiles, and also determine a trend associated with the profile states, for the purpose of determining whether or not a customer is likely to transition from one profile state to another profile state. The activity profiles and trend mapping module 414 can thus generate the profile states and respective probability scores discussed above, as well as generate scores indicating likelihood of transitioning between different profile states by a customer.

A lifestyle segmentation and pattern discovery module 416 is able to segment customers by groups, such as based on age, gender, and so forth. Also, the lifestyle segmentation and pattern discovery module 416 can identify patterns in segments of the customer lifestyle profiles.

A performance indicators and recommendations module 418 is able to make recommendations of offerings and/or features of offerings based on the outputs of modules 414 and 416. The performance indicators can be used to provide information regarding what the customers like and do not like. For example, based on the analysis, a report from the module 418 may indicate that customers belonging to a customer lifestyle state, e.g. “active runners,” may consider the enterprise's new product to work on average for 300 miles, and after that, the product has to be replaced. This can provide the enterprise with useful inputs on the performance of the product experienced by a certain group of users; the information can be considered in the enterprise's product development strategy. Additionally, the module 418 can recommend a list of top 10 features that a certain customer lifestyle segment considers as important in a product.

Machine-readable instructions, such as the customer profile generator 114 of FIG. 1 and the various modules of the customer profile generator 114 of FIGS. 3 and 4, can be loaded for execution into one or multiple processors. A processor can include a microprocessor, microcontroller, processor module or subsystem, programmable integrated circuit, programmable gate array, or another control or computing device.

Data and instructions are stored in respective storage devices, which are implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, at a computer, first data from a device, wherein the first data includes a usage pattern of the device by a customer;
receiving, at the computer, second data of the customer from a social media source, the second data including information regarding sentiment about an attribute expressed by the customer; and
determining a profile state of the customer based on the first data and the second data.

2. The method of claim 1, wherein the first data comprises data collected by at least one sensor.

3. The method of claim 1, wherein the profile state indicates a physical activity level of the customer.

4. The method of claim 1 further comprising computing an indication of a probability that the customer is at the profile state.

5. The method of claim 4, wherein computing the indication of the probability comprises computing a score using a statistical model.

6. The method of claim 1 further comprising calculating a probability that the customer will transition from the profile state to another profile state.

7. The method of claim 1, wherein the first data comprises structured data.

8. The method of claim 7, wherein the second data comprises unstructured data.

9. The method of claim 1 further comprising recommending a characteristic of an offering in response to a customer lifestyle profile including the profile state.

10. A system comprising:
at least one processor to:
receive first data from a sensor indicating a usage pattern of a device by a customer;
receive second data from a social media source, the second data including a sentiment expressed by the customer about an attribute of an offering; and
generate, based on the first data and the second data, a customer lifestyle profile that includes a profile state of the customer and an indication of a probability that the customer is at the profile state.

11. The system of claim 10, wherein the first data received from the sensor indicates a physical activity level of the customer.

12. The system of claim 10, wherein the customer lifestyle profile includes a plurality of profile states and associated indications of probability that the customer is at the respective profile states, wherein at least some of the profile states are associated with a physical activity level dimension.

13. The system of claim 10, wherein each of the first data is organized by customer identifier and by time.

14. The system of claim 10, wherein the at least one processor is to determine profile states to include in the customer lifestyle profile.

15. The system of claim 14, wherein determining of the profile states is based on historical information.

16. The system of claim 14, wherein determining of the profile states is based on the first data and the second data.

17. The system of claim 10, wherein the at least one processor is to determine, based on the first data and the second data, a probability of transitioning from the profile state to another profile state.

18. An article comprising at least one machine-readable storage medium storing instructions that upon execution cause a system to:
receive first data from a device, wherein the first data includes a usage pattern of the device by a customer;
receive second data of the customer from a social media source, the second data including information regarding sentiment about an attribute expressed by the customer;
determine profile states of the customer based on the first data and the second data; and
compute scores indicating probabilities that the customer is at the respective profile states.

19. The article of claim 18, wherein the instructions upon execution cause the system to further identify a new offering or a new feature of an existing offering based on the profile states and the computed scores.
